(19) United States
(12) Patent Application Publication
(10) Pub. No.: US 2026/0316023 A1
(43) Pub. Date: Oct. 15, 2026

(54) AN ARRANGEMENT FOR PROVIDING A FLOW OF FOOD PRODUCT COMPRISING A LIQUID WITH PARTICLES, A FILLING MACHINE AND A METHOD

(71) Applicant: Tetra Laval Holdings & Finance S.A., Pully (CH)

(72) Inventors: Henrik GRANE, Lund (SE); Mikael OLSSON, Lund (SE); Lasse ANDERSEN, Lund (SE); Jimmy MAGNUSSON, Lund (SE); Stefan SLÄTTERYD, Lund (SE); Thomas WIESE, Lund (SE)

(73) Assignee: Tetra Laval Holdings & Finance S.A., Pully (CH)

(21) Appl. No.: 19/483,672

(22) PCT Filed: May 29, 2024
(86) PCT No.: PCT/EP2024/064700

§ 371 Date: Nov. 12, 2025

(30) Foreign Application Priority Data
Jun. 7, 2023 (EP) 23178006.5

(51) Int. Cl. B01F 27/9212; B01F 27/1145; B01F 35/30; B01F 101/06; B65B 3/04

(52) U.S. Cl. CPC B01F 27/9212; B01F 27/11451; B01F 35/30; B65B 3/04; B01F 2035/3512; B01F 2101/06

(57) ABSTRACT

An arrangement for providing a flow of agitated food product comprising a liquid with particles is presented. The arrangement comprises: a product tank configured to buffer the food product, wherein a bottom portion of the product tank has a conical shape; an agitator arranged inside the product tank, said agitator comprising a shaft extending along the main axis and an agitator device wherein the agitator device comprises an outer and an inner helix member, wherein a respective radius of the outer and inner helix member gradually increases from a bottom end to a top end of the outer and inner helix member, wherein the respective bottom end of the outer and inner helix member is connected to a lower end of the shaft via a respective first and second connecting member, wherein the outer helix member is connected to the first connecting member at a first radial distance from the shaft and the inner helix member is connected to the second connecting member at a second radial distance from the shaft, wherein the second radial distance is shorter than the first radial distance.

### TECHNICAL FIELD

The invention relates to packaging technology. More particularly, it is related to an arrangement comprising a product tank and an agitator for providing a flow of agitated food product, a filling machine comprising the arrangement and a method for filling food product into packages.

### BACKGROUND ART

Today, it is increasingly popular with liquid food products comprising particles. For instance, yoghurt with fruit pieces are gaining market share from plain yoghurt, that is, yoghurt without fruit pieces. Even though liquid food products with particles have been around for quite some time, there are some challenges with processing these products that do not exist when processing the plain products. For instance, during heat treatment, if not appropriate equipment is used, there is a risk that the particles are not heated treated adequately, and as an effect there may be a risk that the bacteria, germs, spores or other microorganisms contained in the particles are not killed off. As an effect, the food product may not be safe to consume. Still an issue that needs to be considered with the food products with particles is that there is an increased risk during cleaning. The particles may namely be more difficult to remove than the liquid. For instance, if using tubular heat exchangers with baffles, there may be an increased risk that the particles get stuck in the baffles, which as an effect may result in a hygienic issue. For this reason, such heat exchangers are often not used for food products with particles.

A particular challenge with the particle-containing food products is how to make sure that a consistent particle distribution is achieved in the packages. Put differently, each package should contain more or less the same amount of particles.

To provide for that the food product fed into the packages contain an even distribution of particles, a buffer tank with an agitator can be used upstream a filling station. By rotating the agitator, a circulation of the food product is obtained and as an effect of this circulation, the risk of having the particles gathered in a bottom of the buffer tank can be prevented. Instead, a more even distribution of particles is achieved. Even though there are solutions for providing an even distribution of the particles before having the food product fed to the filling station, there is a need for equipment that can provide improved consistent agitation, i.e. provide consistent distribution of the particles, that is easy to manufacture and that has low maintenance need, e.g. low risk of machine failure and efficient cleaning.

### SUMMARY

It is an object of the invention to at least partly overcome one or more of the above-identified limitations of the prior art. In particular, it is an object to provide an arrangement for providing a flow of agitated food product that can provide reliable and consistent agitation such that an even distribution of particles can be provided in a flow of product fed out from the arrangement.

According to a first aspect it is provided an arrangement for providing a flow of agitated food product comprising a liquid with particles. The arrangement comprises:
a product tank configured to buffer the food product, said product tank having a feed inlet and a feed outlet, said feed outlet being arranged at a bottom portion of the product tank, wherein the bottom portion of the product tank has a conical shape;
an agitator arranged inside the product tank in a rotatable manner about a main axis of the product tank, said agitator comprising a shaft extending along the main axis, and an agitator device configured to, during use, agitate the food product in the product tank,
wherein the agitator device comprises an outer and an inner helix member, said outer helix member being arranged radially outside said inner helix member,
wherein a respective radius of the outer and inner helix member gradually increases from a bottom end to a top end of the outer and inner helix member,
wherein the respective bottom end of the outer and inner helix member is connected to a lower end of the shaft via a respective first and second connecting member,
wherein the outer helix member is connected to the first connecting member at a first radial distance from the shaft, and the inner helix member is connected to the second connecting member at a second radial distance from the shaft, wherein the second radial distance is shorter than the first radial distance.

An advantage with having the inner and outer helix members arranged at distances from the shaft is that cleaning of the tank can be facilitated at the same time as efficient agitation is achieved during production. By having the distances between the shaft and the helix members, water and cleaning agents are namely allowed to pass between the shaft and the helix members, which provides for efficient cleaning. Put differently, by avoiding to have the helix members attached directly to the shaft such that corner areas are formed in intersection areas between the helix members and the shaft, a risk of having food residues stuck on the agitator can be reduced.

Having the shaft extending all the way down to the bottom ends of the outer and inner helix members provides reliability and also reduced risk of manufacturing difficulties. The shaft provides rigidity and the risk of deformation of the helix members during operation can therefore be reduced. Having the distances between the shaft and the helix members also reduce the need for welding and polishing of the welds compared to having the helix members directly attached to the shaft without distances.

The first connecting member may extend away from the shaft in a first direction transverse to the main axis, and the second connecting member may extend away from the shaft in a second direction transverse to the main axis.

The first direction may be opposite to the second direction.

The gradual increase in radius of the outer and inner helix member may follow the conical shape of the product tank.

By having the radial increase of the outer and inner helix members following the radial increase of the tank provides for that the vertical exchange of the particles in the food product can be controlled in an improved manner. Put differently, a shape of the helix members may in combination with a shape of the tank provide for that efficient mixing is obtained, thereby enabling that a flow of food product with an even particle distribution can be provided.

The outer helix member may be configured to push the liquid food product upwards in the product tank, and the inner helix member may be configured to push the liquid food product downwards in the product tank.

A rotational direction around the shaft of the outer helix member may be opposite to a rotational direction of the inner helix member.

The outer helix member may further be connected to the shaft via a third connecting member, and the inner helix member may further be connected to the shaft via a fourth connecting member,
wherein the third and fourth connecting members may be arranged at a position on the shaft above the first and second connecting members.

The third connecting member may be connected to the outer helix member at a position on the shaft below the top end of the outer helix member, such that said top end of the outer helix member is free.

An advantage with having the top end of the outer helix member free, that is, having no connecting member placed in the top end, is that this allows for a smaller tank opening. By having this end free, the agitator can namely be fitted into a smaller opening compared to if there was a connecting member attaching the top end to the shaft. Having a smaller opening in turn comes with the positive effect that a mechanical seal of a lid covering the opening can be made smaller.

The product tank may further comprise a tank opening through which the agitator can be inserted and/or removed, said tank opening having a tank opening radius; and
wherein a largest radius of the outer helix member is greater than the tank opening radius of the tank opening.

The arrangement may further comprise a tank lid configured to close the tank opening,
wherein the shaft may be mountable through the tank lid through a mechanical seal with a filtered air barrier.

The outer helix member and the inner helix member may have a rectangular cross-section.

The outer helix member and the inner helix member may each have an angular rotation of between 400 and 700 degrees, about the main axis.

The arrangement may further comprise a first and a second spray device, wherein a respective main axis of the first and second spray device may be offset by an angle from the main axis of the product tank, such that the first and second spray device are directed towards a center of the product tank.

Having the first and second spray device, sometimes referred to as spray balls, inside the tank and having these inclined towards a center of the tank provides for that water and/or cleaning agents can be sprayed onto the outer and inner helix members such that food residues can efficiently be removed. As an effect, cleaning time can be reduced, and also water and/or cleaning agent consumption can be held low. Additionally, having the first and second spray device at an angle also provides for improved cleaning of a tank lid, and any components arranged at the tank lid, such as sensors, a tank lid sealing or a sealing around the shaft.

According to a second aspect it is provided a filling machine arranged to fill food product into a package, the filling machine may comprise an arrangement according to the first aspect.

According to a third aspect it is provided a method for filling food product into packages, said food product comprising a liquid with particles, the method may comprise:
feeding the food product to an arrangement according to the first aspect, agitating the food product filled inside the product tank by rotating the agitator arranged inside the product tank, such that an even particle distribution of the food product is obtained,
feeding the food product from the product tank and to a filling station, and operating the filling station to fill the food product into the packages.

The filling station may be part of a line with different stations for forming and filling packages or it may also form an integral part of a filling machine, i.e. one piece of equipment both forming and filling packages. The filling station may be arranged to fill bottles or the like, but also carton-based packages made from blanks or a web of packaging material can be used.

The same features and advantages as presented above with respect to the first aspect also apply to this third aspect.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1A illustrates a cross-sectional view of an arrangement for providing a flow of agitated food product.

FIG. 1B illustrates a perspective view illustrating how the agitator may be removed and inserted via an opening provided in the product tank.

FIG. 2 illustrates a perspective view of an agitator of the arrangement in further detail.

FIG. 3A illustrates a side view of the agitator.

FIG. 3B illustrates another side view of the agitator.

FIG. 4A illustrates a bottom view of the agitator.

FIG. 4B illustrates a top view of the agitator.

FIG. 5A illustrates an outer helix member of the agitator from above.

FIG. 5B illustrates a side view of the outer helix member.

FIG. 5C illustrates a cross-sectional view of the outer helix member.

FIG. 6A illustrates an inner helix member of the agitator from above.

FIG. 6B illustrates a side view of the inner helix member.

FIG. 6C illustrates a cross-sectional view of the inner helix member.

FIG. 7A illustrates schematically a filling machine comprising the arrangement according to a first example.

FIG. 7B illustrates schematically a filling machine comprising the arrangement according to a second example.

FIG. 8 is a flowchart illustrating a method for filling food product into packages.

### DETAILED DESCRIPTION

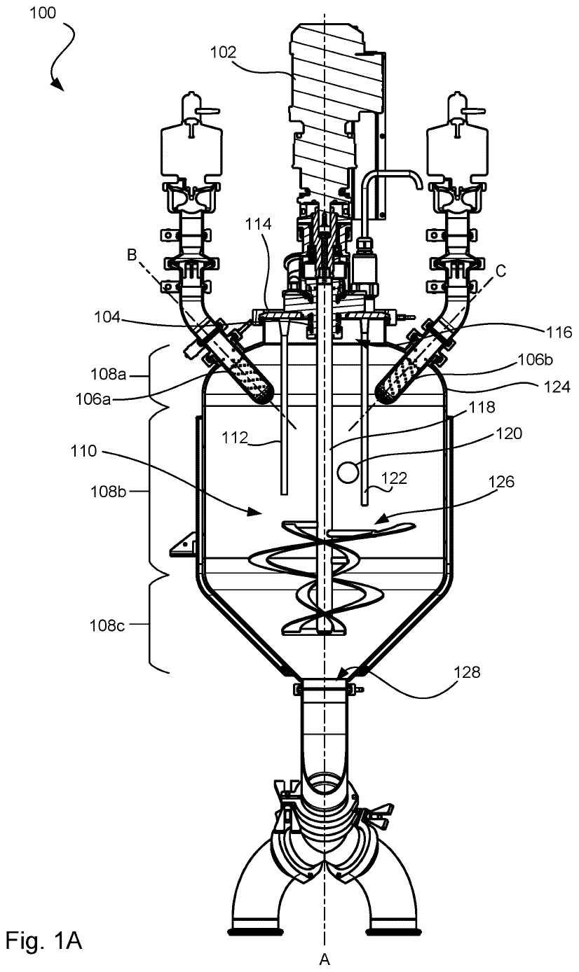

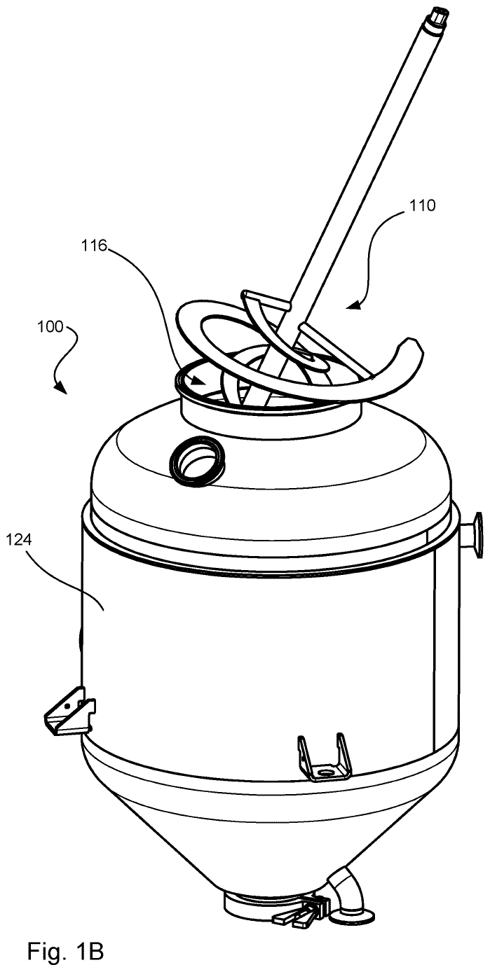

FIG. 1A illustrates a cross-sectional view of an arrangement 100 for providing a flow of agitated food product. As illustrated, a motor 102 may be provided in an upper end of the arrangement 100. The motor 102 can be arranged for rotating a shaft 118 inside a product tank 124. To provide for that the tank 124 is closed off from surrounding air such that microorganisms cannot reach the food product inside the tank 124, a mechanical seal 104 may be provided. The mechanical seal 104 may be a double mechanical seal with an air barrier. Filtered air may be provided into the mechanical seal 104 to provide for that the food product is shielded from the surrounding air. The shaft 118 can be running through a tank lid 114 provided with the mechanical seal 104. In this way, the shaft 118 may be placed partly inside the tank and partly outside the tank.

In a top portion 108a of the tank, a first and a second spray device 106a, 106b can be placed. As illustrated, the first spray device 106a may extend in a main axis B, and the second spray device 106b may extend in a main axis C. The two main axes B, C of the first and second spray device 106a, 106b may be directed such that these two are inclined towards the shaft 118, extending in a main axis A.

As illustrated, the top portion 108 of the tank 124 may be dome-shaped, a mid-portion 108b may be cylindrically shaped and a bottom portion 108c may be conically shaped.

An agitator 110 may be attached to the shaft 124 such that a rotation of the shaft 124 around the main axis A provides for that that the food product inside the tank is agitated.

A level sensor 112 may be provided such that a level of food product inside the tank 124 can be monitored. Even though not illustrated, the level sensor 112 may generate level sensor data that can be transmitted to a control unit or other data processing apparatus. A temperature sensor 122 may also be provided such that a temperature of the food product inside the product tank 124 can be monitored. The temperature sensor 122 can generate temperature sensor data that can be transmitted to the control unit or other data processing apparatus. As illustrated, the level sensor 112 and/or the temperature sensor 122 may be attached to an underside of the tank lid 114.

As illustrated, a tank opening 116 may have a diameter that is less than a diameter of the mid-portion 108b of the product tank 124. An advantage of having a smaller diameter of the opening 116 is that less energy is needed for cooling the mechanical seal. Further, by having the diameter of the opening 116 being less than the diameter of the mid-portion 108b, it can be easier to assure that pressure differences between an inside pressure of the tank 124 and a pressure outside the tank do not pose any risk to operators or other personnel.

The food product can be fed into the tank 124 via a feed inlet 120 in the mid-portion 108b of the tank 124. After being agitated, the food product can be fed out from the tank 124 via a feed outlet 128 placed in a bottom portion 108c of the tank 124.

As illustrated, the agitator 110 can comprise an agitator device 126. The agitator device 126 may be conically shaped such that this can be fitted into the conically shaped bottom portion 108c of the tank 124. The conically shaped bottom portion 108c combined with the conically shaped agitator device 126 can provide for that the food product is circulated vertically in an efficient manner within the tank 124.

As explained above, the advantages with having the tank opening 116 small include more efficient mechanical seal as well as that pressure differences can be handled more efficiently. As illustrated in FIG. 1B, by having the agitator device 126 of the agitator 110 designed wisely, it is possible to have a maximum radius of the agitator device 126 larger than a radius of the tank opening 116, even so that the maximum radius of the agitator device 126 is larger than a diameter of the tank opening 116. This can be achieved by having a peripheral end of an outer helix member 130 of the agitator device 126 hanging freely. Put differently, a connecting member, attaching the outer helix member 130 to the shaft 118, can be placed at a distance from the peripheral end such that the agitator 110 can be inserted via the opening 116 by rotating and leaning the agitator 110.

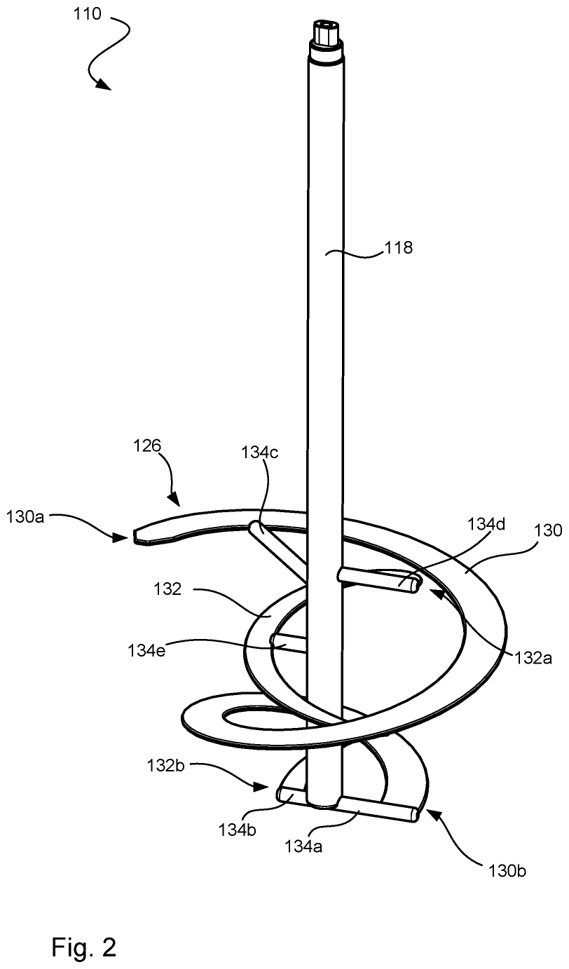

FIG. 2 illustrates the agitator 110 in further detail by way of example. As illustrated, the agitator device 126 can comprise an outer helix member 130 and an inner helix member 132. These two may be arranged such that when the shaft 118 is rotating around the main axis A, the inner helix member 132 pushes the food product, including the particles, downwards, while the outer helix member 130 pushes the food product, including the particles, upwards. In this way, the food product is circulated both around the main axis A as well as vertically. Even though illustrated that the outer helix member 130 is pushing the food product upwards and the inner helix member 132 is pushing the food product downwards, the two members can also be arranged to provide a vertical flow in an opposite direction, that is, having the outer helix member 130 arranged to push the food product downwards and the inner helix member 132 arranged to push the food product upwards.

The outer helix member 130 has a top end 130a and a bottom end 130b. Similarly, the inner helix member 132 has a top end 132a and a bottom end 132b. As illustrated, the bottom end 130b of the outer helix member 130 may be attached to the shaft 118 via a first connecting member 134a. This first connecting member 134a may be transversally arranged. A second connecting member 134b can be attaching the bottom end 132b of the inner helix member 132. A third connecting member 134c may be attaching the top end 130a of the outer helix member 130. As discussed above, to facilitate insertion and removal of the agitator 110 via the tank opening 116, the third connecting member 134c may be placed at a distance from the top end 130a, also referred to as the peripheral end, of the outer helix member 130. A fourth connecting member 134d may be used for attaching the top end 132a of the inner helix member 132 to the shaft 118. A fifth connecting member 134e may be provided in a mid-portion of the inner helix member 132. As illustrated, both the first and second helix members 130, 132 can be conically shaped. Put differently, the radius of the helix members 130, 132 can increase as a function of a distance from the bottom end 130b, 132b.

The first to fifth connecting members 134a-e may be cylindrically shaped, as illustrated, and the first and second helix members 130, 132 may have rectangular cross-sections. As an effect, less effect on the food product in terms of movement is caused by the connecting members 134a-d compared to the first and second helix members 130, 132.

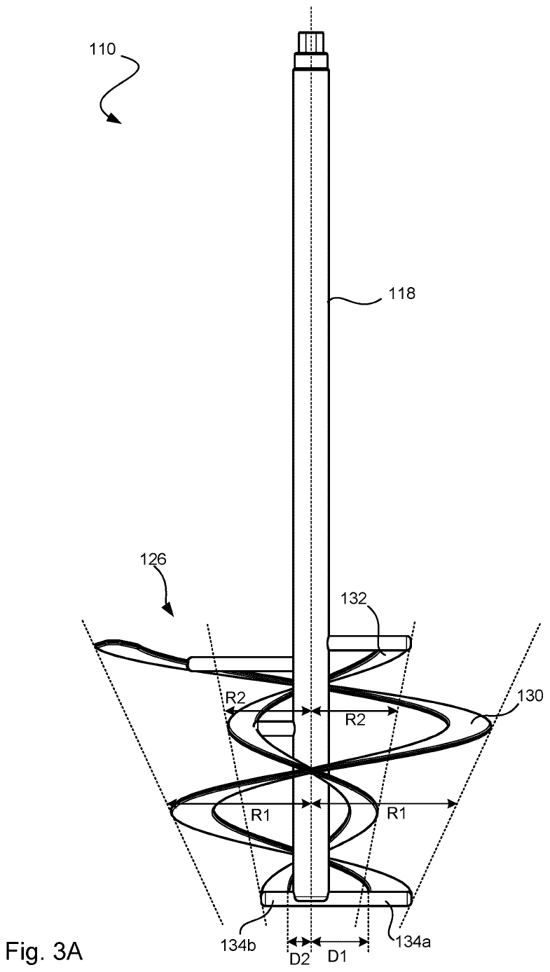

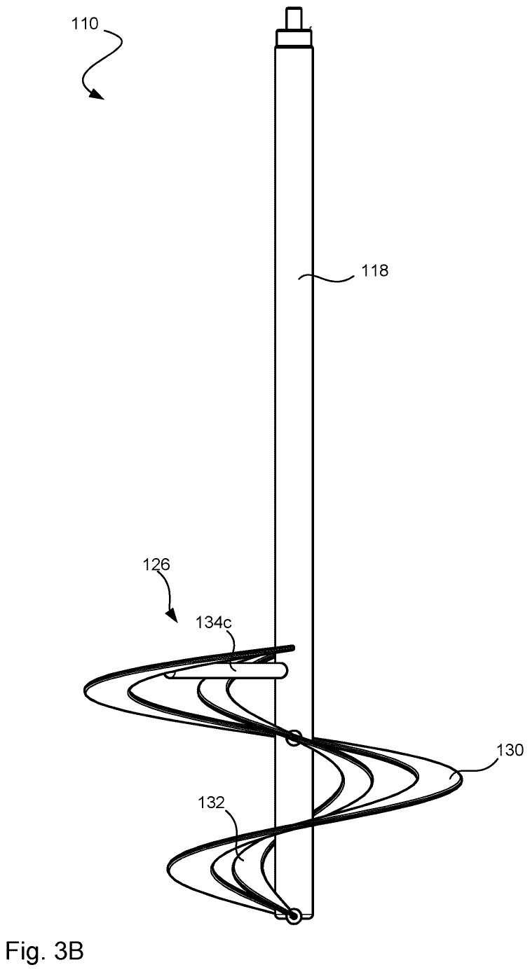

FIG. 3A illustrates a side view of the agitator 110 by way of example. As illustrated, the outer helix member 130 may have a first radius R1 that increases with the height, that is, a distance from a bottom of the shaft 118. The inner helix member 132 may have a second radius R2 that also increases with the height. As illustrated, the second radius R2 may increase to a lesser degree than the first radius R1. The gradual increase of the first and/or second radius R1, R2 may be adjusted in accordance with the conical shape of the bottom portion 108c of the tank 124 such that efficient agitation can be achieved. As illustrated, a rotational direction around the shaft 118 of the outer helix member 130 can be opposite to a rotational direction of the inner helix member 132.

The outer helix member 130 may be connected to the first connecting member 134a at a first radial distance D1 from the shaft 118, and the inner helix member 132 may be connected to the second connecting member 134b at a second radial distance D2 from the shaft 118. The second radial distance D2 may be shorter than the first radial distance D1. By having the helix members 130, 132 arranged in this way, a distance between the shaft 118 and the helix members 130, 132 may be provided. An effect of this distance, which may be different for the two members and also different at different positions of the two members, is that a risk of insufficient cleaning can be reduced. Having the helix members 130, 132 directly attached to the shaft, that is, no distance, may namely result in that corner areas are formed that may difficult to keep clean. If food residues are getting stuck, there is a risk that these food residues negatively affect coming food product handled in the tank 124. For instance, the insufficient cleaning may result in a food product that is not safe to consume.

If having the corner areas, sufficient cleaning may nevertheless be achieved by using additional cleaning agents, more water, longer cleaning time, etc. However, the result of this is reduced productivity, due to increased cost and time for cleaning, and also in that the environmental footprint is negatively affected.

FIG. 3B illustrates another side view of the agitator 110. The side view illustrated in FIG. 3B is perpendicular to the side view illustrated in FIG. 3A.

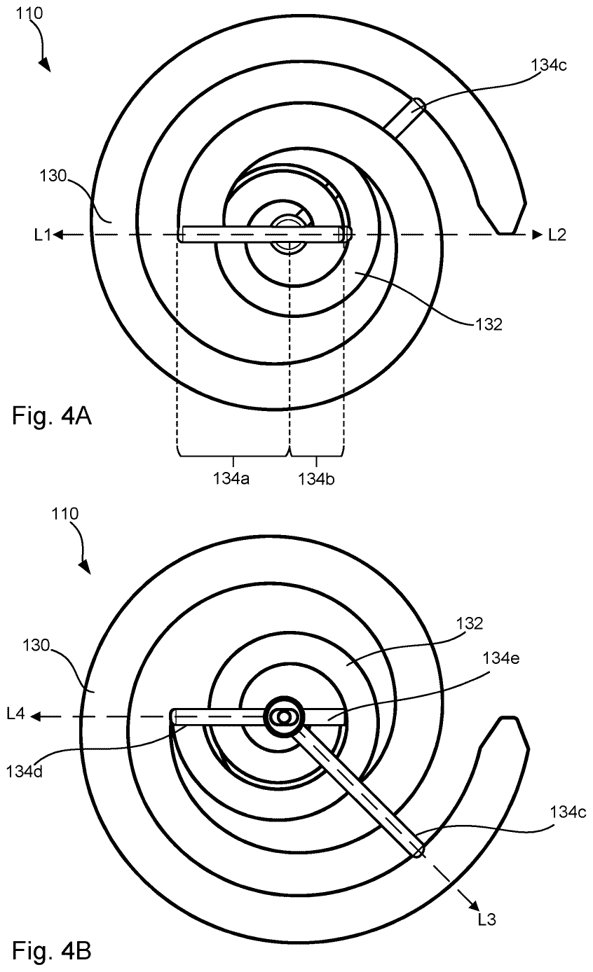

FIG. 4A illustrates a bottom view of the agitator 110. As illustrated in this view, the first and second connecting members 134a, 134b may be arranged in a first and a second direction, respectively, L1, L2. The first direction L1 and the second direction L2 may both extend away from the shaft 118 and they may, as illustrated, be opposite to one another. As discussed above, the third connecting member 134c may be arranged at a distance from the top end 13a of the outer helix 130 such that a peripheral end of the outer helix member 130 is free, that is, free from any connecting members, thereby enabling the tank opening 116 with a smaller diameter.

FIG. 4B illustrates a top view of the agitator 110. As illustrated in this view, the third and fourth connecting member 134c, 134d may be arranged in a third and a fourth direction, L3, L4, respectively. The third direction L3 and the fourth direction L4 may both extend away from the shaft 118 and they may, as illustrated, extend at an angle other than 180 degrees (as compared to the first and second connecting members 134a, 134b in FIG. 4A). This may provide for the top end 130a of the outer helix 130 to be free.

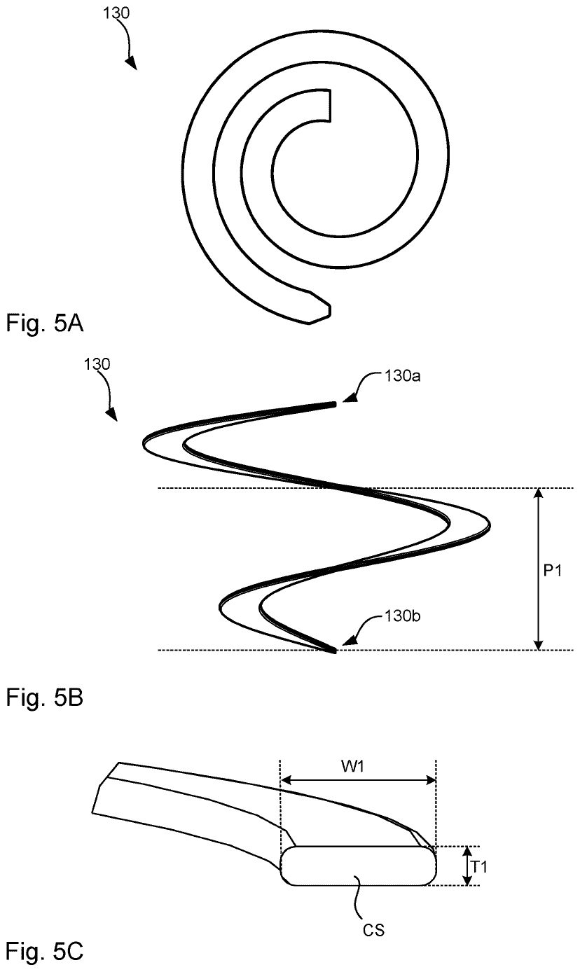

FIG. 5A illustrates the outer helix member 130 in isolation by way example seen from above. As illustrated, the top end 130a may be tapered such that swirls or other effects on the food product in the tank can be reduced during rotation of the shaft 118. In particular, the tapered end may provide for the outer helix member 130 engaging the food product with a reduced damage to the particles of the food product.

The outer helix member 130 (as well as the inner helix member 132 further described below) may be manufactured from a sheet metal. As seen in FIG. 5A, the outer helix member 130 can be cut out from a single sheet metal. The top and bottom end 130a, 130b can then be moved apart to form the helix as illustrated in FIG. 5B.

By having the outer and inner helix member 130, 132 produced with the sheet metal as a starting point, cost efficient manufacturing can be achieved.

In the illustrated example, an angular rotation of the outer helix member 130 is 540 degrees.

FIG. 5B illustrates a side view of the outer helix member 130. As illustrated, the outer helix member 130 may have a first pitch P1.

FIG. 5C illustrates a cross-sectional view of the outer helix member 130. As discussed above, the member may be provided with a rectangular cross-section CS. To avoid swirls and also to provide for that cleaning is facilitated, edges may be beveled. The cross-section CS may have a first width W1 and a first height T1 as illustrated. Preferably, the first width W1 is greater than the first height T1. An effect of this may be that the outer helix member has a low damaging effect on the food product. In other words, the risk of damaging the particles of the food product by the agitator device 126 may be reduced.

Having a rectangular cross-section as compared to a circular or elliptical cross-section may provide for an increased agitation of the food product, by increasing the upward and downward motion of the food product.

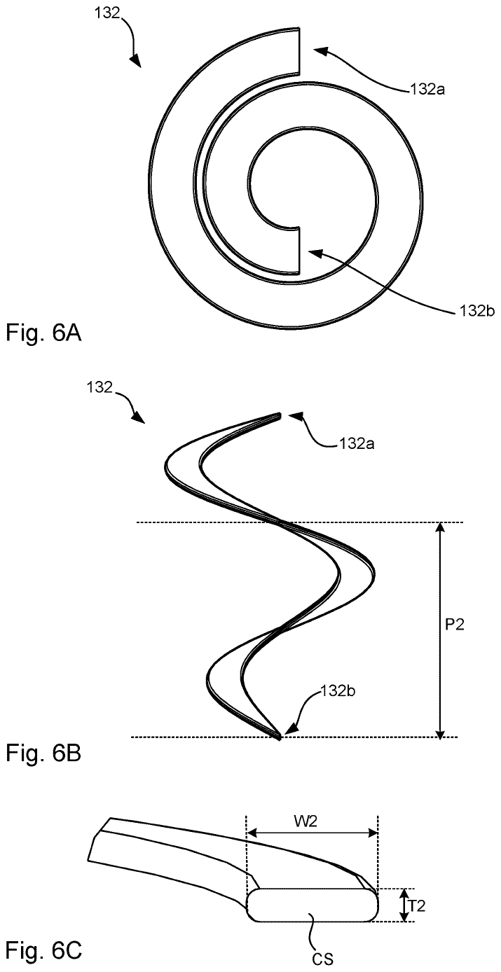

FIG. 6A illustrates the inner helix member 132 in isolation by way example seen from above. As illustrated, the top end 132a and the bottom end 132b may both be provided with edges adapted to be attached to the second connecting member 134b and the fourth connecting member 134d, respectively, as illustrated in FIG. 2.

In the illustrated example, an angular rotation of the inner helix member 132 is 540 degrees.

FIG. 6B illustrates a side view of the inner helix member 132. As illustrated, the outer helix member 130 may have a second pitch P2.

FIG. 6C illustrates a cross-sectional view of the inner helix member 132. As discussed above, the member may be provided with a rectangular cross-section CS.

Similar to the outer helix member 130, edges may be beveled. The cross-section CS may have a second width W2 and a second height T2 as illustrated. The cross-section CS of the inner helix member 132 may be the same as the outer helix member 130.

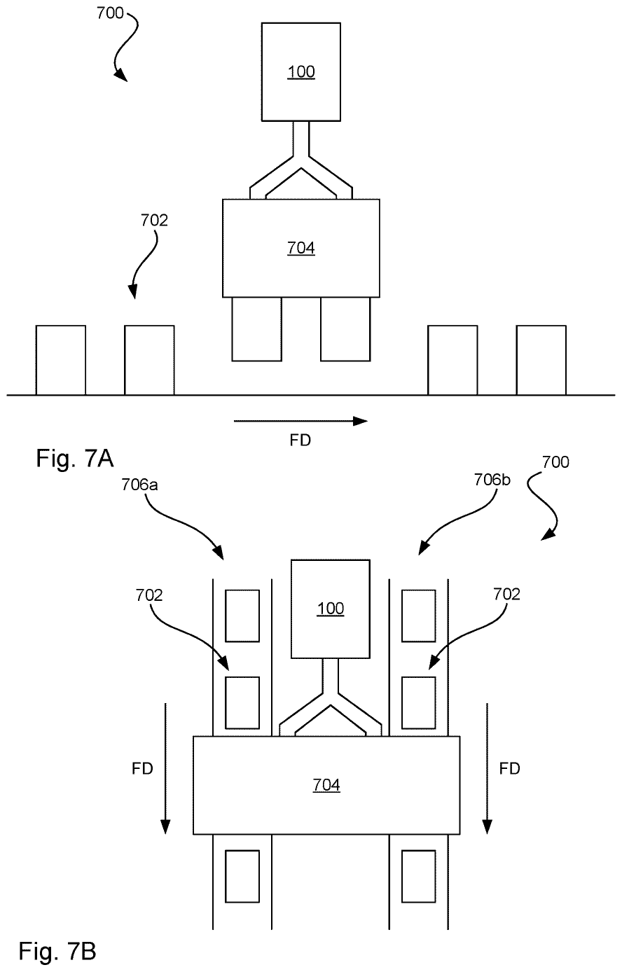

FIG. 7A illustrates schematically, in a side view, a filling machine 700 comprising the arrangement 100 illustrated FIGS. 1A and 1B by way of a first example. As illustrated, the arrangement 100 may be arranged above a filling station 704 such that the food product can be fed from the arrangement 100 down into the filling station 704. The filling station 704 may be arranged to fill two packages 702 at a time, and the filling process may involve lifting the packages 702 and during filling lowering the packages such that a more controlled filling can be obtained (the lifting and lowering may be achieved by having a servo-motor controlled plate placed under the packages, not illustrated). The packages may be fed on a conveyor belt or similar arrangement configured for intermittently moving the packages in a feeding direction FD. Even though not illustrated, the food product may be fed into the arrangement 100 from a food processing line placed upstream the filling machine 700. Another option, even though not illustrated, is to have filling nozzles of the filling station to move alongside the package during filling such that intermittent movement of the packages can be avoided.

FIG. 7B illustrates schematically, in a top view, a filling machine 700 comprising the arrangement 100 illustrated in FIGS. 1A and 1B by way of a first example. As in the example of FIG. 7A, the arrangement 100 may be arranged above the filling station 704. The filling station 704 of the present example, supplies a first and a second packaging line 706a, 706b. The first and second packaging line 706a, 706b are parallel to each other. Even though it is illustrated that the arrangement 100 is providing the food product to two packaging lines 706a, 706b, the approach can also be used for more than two packaging lines.

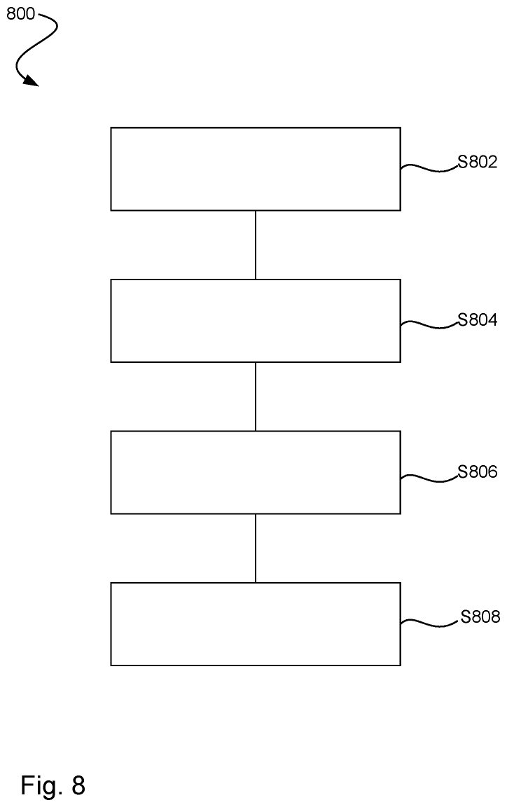

FIG. 8 is a flowchart illustrating a method 800 of filling a food product into the packages 702. As illustrated, the method may comprise feeding S802 the food product to the arrangement 100, agitating S804 the food product filled inside the product tank by rotating the agitator arranged inside the product tank, such that an even particle distribution of the liquid food product is obtained, feeding S806 the food product from the product tank and to a filling station, and operating S808 the filling station to fill the liquid food product into the packages. As discussed, the filling station may form part of the filling machine.

From the description above follows that, although various embodiments of the invention have been described and shown, the invention is not restricted thereto, but may also be embodied in other ways within the scope of the subject-matter defined in the following claims.

1. An arrangement for providing a flow of agitated food product comprising a liquid with particles, the arrangement comprising:
a product tank configured to buffer the food product, said product tank having a feed inlet and a feed outlet, said feed outlet being arranged at a bottom portion of the product tank, wherein the bottom portion of the product tank has a conical shape;
an agitator arranged inside the product tank in a rotatable manner about a main axis of the product tank, said agitator comprising a shaft extending along the main axis, and an agitator device configured to, during use, agitate the food product in the product tank,
wherein the agitator device comprises an outer and an inner helix member, said outer helix member being arranged radially outside said inner helix member,
wherein a respective radius of the outer and inner helix member 132) gradually increases from a bottom end to a top end of the outer and inner helix member,
wherein the respective bottom end of the outer and inner helix member is connected to a lower end of the shaft via a respective first and second connecting member,
wherein the outer helix member is connected to the first connecting member at a first radial distance from the shaft, and the inner helix member is connected to the second connecting member at a second radial distance from the shaft, wherein the second radial distance is shorter than the first radial distance.

2. The arrangement according to claim 1, wherein the first connecting member extends away from the shaft in a first direction transverse to the main axis, and the second connecting member extends away from the shaft in a second direction transverse to the main axis.

3. The arrangement according to claim 2, wherein the first direction is opposite to the second direction.

4. The arrangement according to claim 1, wherein the gradual increase in radius of the outer and inner helix member follows the conical shape of the product tank.

5. The arrangement according to claim 1, wherein the outer helix member is configured to push the liquid food product upwards in the product tank, and the inner helix member is configured to push the liquid food product downwards in the product tank.

6. The arrangement according to claim 1, wherein a rotational direction around the shaft of the outer helix member is opposite to a rotational direction of the inner helix member.

7. The arrangement according to claim 1, wherein the outer helix member is further connected to the shaft via a third connecting member, and the inner helix member is further connected to the shaft via a fourth connecting member, wherein the third and fourth connecting members are arranged at a position on the shaft above the first and second connecting members.

8. The arrangement according to claim 7, wherein the third connecting member is connected to the outer helix member at a position on the shaft below the top end of the outer helix member, such that said top end of the outer helix member is free.

9. The arrangement according to claim 1, wherein the product tank further comprises a tank opening through which the agitator can be inserted and/or removed, said tank opening having a tank opening radius; and
wherein a largest radius of the outer helix member is greater than the tank opening radius of the tank opening.

10. The arrangement according to claim 9, wherein the arrangement further comprises a tank lid configured to close the tank opening,
wherein the shaft is mountable through the tank lid through a mechanical seal with a filtered air barrier.

11. The arrangement according to claim 1, wherein the outer helix member and the inner helix member have a rectangular cross-section.

12. The arrangement according to claim 1, wherein the outer helix member and the inner helix member each have an angular rotation of between 400 and 700 degrees, about the main axis.

13. The arrangement according to claim 1, wherein the arrangement further comprises a first and a second spray device, wherein a respective main axis of the first and second spray device is offset by an angle from the main axis of the product tank, such that the first and second spray device are directed towards a center of the product tank.

14. A filling machine arranged to fill food product into a package, the filling machine comprising an arrangement according to any one of the preceding claims.

15. A method for filling food product into packages, said food product comprising a liquid with particles, the method comprising:
feeding the food product to an arrangement according to claim 1,
agitating the food product filled inside the product tank by rotating the agitator arranged inside the product tank, such that an even particle distribution of the food product is obtained,
feeding the food product from the product tank and to a filling station, and
operating the filling station to fill the food product into the packages.
